(19) United States
(12) Patent Application Publication
(10) Pub. No.: US 2006/0136258 A1
(43) Pub. Date: Jun. 22, 2006

(54) Health care incentive system and method for operating a health care incentive system

(76) Inventors: Kimberly K. Horn, Ada, MI (US); Jodie E. Southwell, Ada, MI (US); Cheryl Ann Osentoski, Wayland, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 11/015,108

(22) Filed: Dec. 17, 2004

(51) Int. Cl. G06Q 10/00; G07G 1/14

(52) U.S. Cl. 705/2; 705/14

(57) ABSTRACT

A health care incentive system comprises a means for accumulating health care information and means for analyzing the health care information in order to develop a set of commitments for the individual in the health incentive program. If the individual achieves the commitments over a predetermined period of time, an incentive is provided to the individual.

### BACKGROUND OF THE INVENTION

The wellness of a person is directly related to that person's lifestyle and whether she obtains effective and continuous treatment for any health conditions. For example, wellness can be negatively effected by excess weight and the use of tobacco products. Similarly, chronic health conditions such as diabetes, asthma, cardiovascular disease and depression are generally manageable so as to avoid further medical complication if the person afflicted with the condition obtains regular care.

While most people generally recognize that an appropriate lifestyle as well regular and continuous checkups and the attendant care increase their health, often an individual is remiss. When that happens, the person's condition may deteriorate. For example, a person afflicted with a cardiovascular disease such as hypertension may need to regularly take medication. As long as the person regularly takes the medication, her condition may not necessarily worsen. However, if the medication is not regularly taken, her condition may rapidly deteriorate, which could ultimately lead to a more serious condition.

While the impact to the person is paramount, the secondary effects of the failure to maintain a healthy lifestyle and obtain regular and continuous treatment are also significant. The cost of regular and continuous treatment of a person for a disease is often much less than the cost of treating the same person if the disease has progressed due to the failure of the person to obtain regular care.

Returning to the example of hypertension, while there is a cost for regular and continuous treatment of a person with hypertension, the cost is much less than for treating that person for a heart problem resulting from the hypertension. If the person is insured, the failure of the person to obtain regular treatment for hypertension results in additional costs to the health care insurance company. The increase in costs to the health care insurance company may result in an increase in the cost of insurance to the person or the person's employer.

In order to improve individual health and offset increased insurance costs, an improved method of encouraging people to maintain a healthy lifestyle as well as obtain regular and continuous medical care is therefore highly desirable.

### SUMMARY OF THE INVENTION

In order to encourage an individual to maintain a healthy lifestyle and attend to regular and continuous medical care, the person is offered an incentive to obtain medical care. The incentive is preferably monetary, but if the person were part of a health plan provided by her employer, the incentive could be additional time-off or any other suitable incentive that is significant enough to encourage a change in behavior.

The award of the incentive is based upon the individual complying with a set of health related commitments for a period of time. The commitments are determined by combining requirements of the employer with the needs of the individual.

If the individual is an employee and the health care plan is provided by the employer, then the employer determines a set of commitments for its eligible employees. These employer commitments may contain requirements for all eligible employees or it may contain requirements for some of the eligible employees. These employer commitments form a superset of commitments.

One commitment could be for the individual to complete a health assessment, which is also referred to as a health quotient. The health assessment is preferably an Internet based assessment and consists of a series of questions relating to the individual's health, lifestyle and behaviors. The health assessment is analyzed to determine whether there are certain areas which should be targeted in order to improve or maintain the individual's health.

Health claims information for the individual may then be analyzed. Health claims information include prior claims for payment from the individuals health care providers as well as for pharmaceuticals. By analyzing the health claims information, certain chronic health conditions may be recognized.

The individual is provided with a notice regarding the commitments and the reward for successfully attaining the commitments for a predetermined length of time, which would usually be a year. The commitments could include items such as regular treatment of a managed disease, getting an annual physical exam and setting a health goal.

During the year, the health care incentive system monitors the person's health claims. The health claims assist in monitoring a participants achievement of the commitments. An online status report is provided to the person so that the person may track the progress toward attaining the commitments. At the conclusion of the year, the health care incentive system analyzes the health claims along with a health appraisal to determine whether the person complied with all the commitments. If the person did meet all the commitments, then the person is provided with an incentive. If not, the person receives no such incentive.

In this manner, a person is encouraged to attain continuous and regular health care, thereby increasing the likelihood that she will minimize the risks of developing a serious health condition.

These and other objects, advantages and features of the invention will be more readily understood and appreciated by reference to the detailed description of the drawings.

### BRIEF DESCRIPTION OF THE DRAWINGS

FIG. 1 shows a computer network for a health incentive system.

FIG. 2 shows the data flow for the system.

FIG. 3 shows a high level data model for the system.

FIG. 4 shows a flow chart for the operation of the health incentive system at the beginning of a plan year.

FIG. 5 shows the operation of the health care incentive system after the individual has completed the health assessment.

FIG. 6 shows the operation of the health care incentive system at the end of the plan year.

### DETAILED DESCRIPTION OF THE DRAWINGS

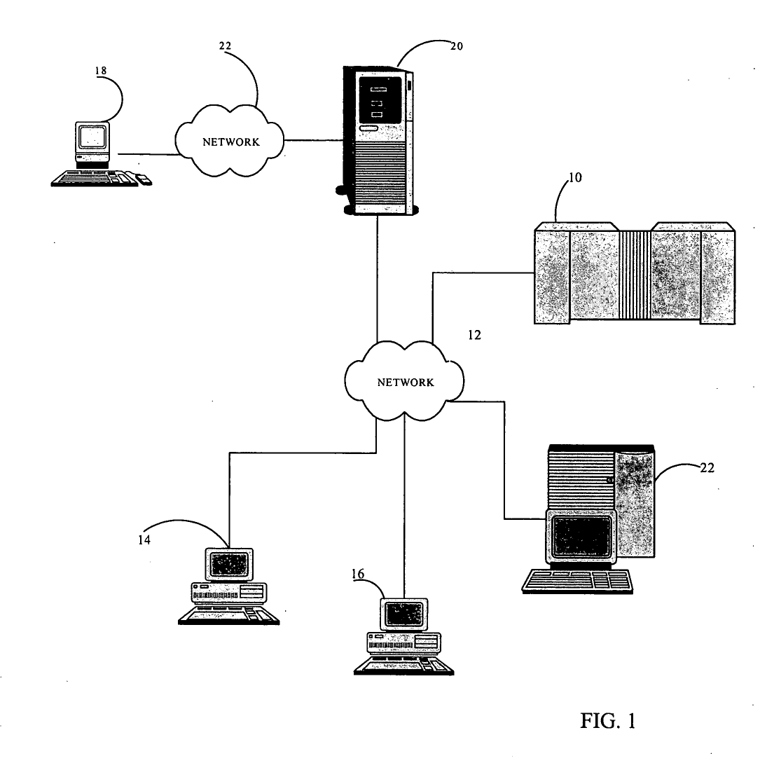

FIG. 1 shows a computer network for a health care incentive system. Data warehouse 10 is connected to a variety of computers by way of network 12.

Health care provider claims processing system 14 provides claim reimbursements for health care providers such as hospitals and physicians. Health care providers submit claims for health care provided to the individual to claims processing system 14. Claims processing system 14 generates a payment to the health care provider and tracks the amount paid on behalf of the individual. Health care provider claims processing system 14 also sends the information to data warehouse 10.

Similarly, pharmacy claims processing system 16 processes claims for pharmaceuticals provided to the individual. It makes payments to pharmacies or other entities which have provided pharmaceuticals for the individual. Information such as the type, amount, and date of the drug claim is forwarded to data warehouse 10.

Claims processing system 14 and pharmacy claims processing system 16 are shown as a single computer. However, each system could be comprised of several computers and data storage systems. Claims processing system 14 and pharmacy claims processing system 16 perform several other functions in managing the payment of claims ancillary to the system described herein.

Personal computer 18 is connected to server 20 by way of network 22. Network 22 could be the same network as network 12, or the two networks could be separate. Personal computer 18 could be located at an employer kiosk or at the individual's home.

Server 20 provides to personal computer 18 a health assessment to be completed by the individual. The health assessment is an online health risk appraisal to develop a “health quotient” for the individual. The questions contained in the health assessment are designed to determine the individual's health risks. The health quotient is one indicator of the overall health of the individual and helps identify managed diseases such as heart disease, stroke, and cancer. The health quotient also is one tool to help assess the individual's risk to develop certain diseases. One example of a suitable Internet based health assessment tool is WebMD® Health Manager, a product of WebMD Corporation, 669 River Drive, Center Two, Elmwood Park, N.J. 07407.

Enterprise computer 22 is utilized by the group in order to provide incentives to individuals. Incentives could be a monetary award, additional time off, or any other incentive which might be used by the group in order to encourage the individuals.

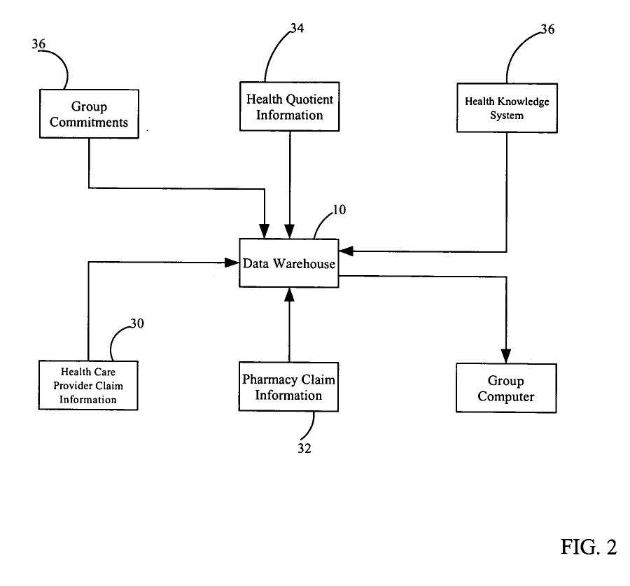

FIG. 2 shows the data flow for the system. Data warehouse 10 receives health care provider claim information 30 and pharmacy claim information 32 from claims processing system 14 and pharmacy claims processing system 16. Health quotient information 34 is also supplied to data warehouse 10.

Group commitments 36 is also provided to data warehouse 10. Group commitments 36 are requirements set by the group which much be fulfilled prior to any incentive being awarded to the individual. For example, group commitments 36 might include completing a health quotient assessment, having a physical examination during a one to two year period, obtaining continuous treatment for a managed disease, and setting a health goal. A health goal could be to lose weight or to stop smoking. A managed disease could be one of several diseases types shown to be controllable by continuous medical care, such as asthma, depression, heart disease, hypertension and diabetes.

Data warehouse 10 also accumulates information from health determination system 36. Health determination system 36 could be a component of data warehouse 10 or it could be based in an external computer system. Health determination system 36 accesses provider claim information 30 and pharmacy claim information 32 as well as health quotient information 34. From this information, health determination system 36 may ascertain whether the individual is afflicted with any managed diseases. Suitable systems for health determination system 36 could be one sold Symmetry Health Data Systems, Inc., 4455 East Camelback Road, Suite C-240, Phoenix, Ariz. 85018 and known generally as “ETG”. Alternatively, a custom software program based upon internally developed information could be used to provide similar functionality.

Data warehouse 10 also could include a verification software program to determine whether the commitments were met by the individual. The verification software program is capable of examining claims and comparing the results of the examination with the individual's commitments to ascertain if the individual met the commitments.

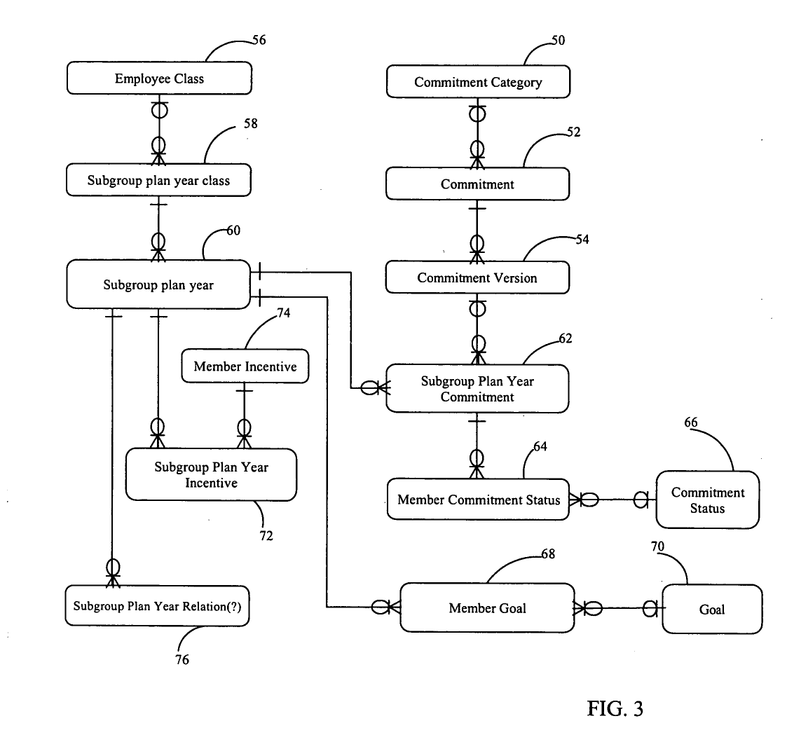

FIG. 3 shows a high level data model for the system. Commitment Category 50 is a broad category used to group and organize commitments. Commitment 52 is a child of commitment category 50. Commitment 52 is a metric for member compliance with one aspect of the employer's program. Commitment 52 has applicability and completion criteria that relate to the plan year, individual enrollment, and sometimes special criteria.

Commitment version 54 is a child of commitment 52. Commitment version 54 is a particular instance of commitment 52. Applicability and completion dates could be associated with commitment version 54.

Employee class 56 indicates the type of employee. Employee subgroup 58 is a child of employee class 56 and shows the type of employees eligible to participate in the health incentive plan. Subgroup plan year 60 indicates the beginning and ending of a plan year.

Subgroup plan year commitment 62 is a child of commitment version 54 and is related to subgroup plan year 60. Subgroup plan year commitment 62 contains the commitments for a specific plan year. Subgroup plan year commitment 62 may change from year to year depending upon a previous year's experience.

Member commitment status 64 indicates the status of each of the individual's commitments for a particular year. Commitment status 66 is indicative of the state of the individual's compliance with the program guidelines in light of the status of each of the individual's commitments.

Member goal 68 is the set of goals a user can choose from. Goal 70 is the specific goal chosen by a user. Subgroup plan year incentive 72 is the incentives offered by an employer subgroup during a given plan year. Member incentive 74 is the set of incentives an employer subgroup may offer to their employees.

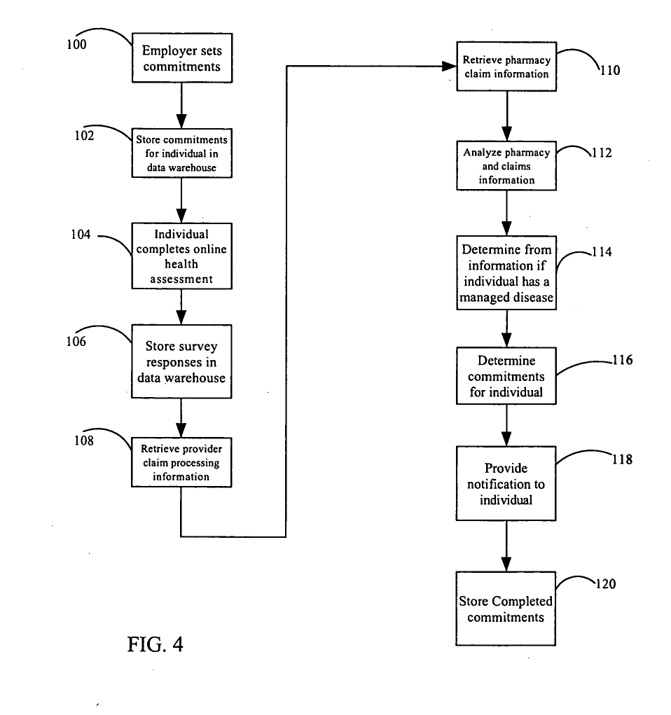

FIG. 4 shows a flow chart for the operation of the health incentive system at the beginning of a plan year. The employer first sets commitments for eligible individuals. Step 100. The commitments are stored in data warehouse 10. Step 102. The individual then completes the health quotient assessment. Step 104. The assessment is also stored in data warehouse 10. Step 106.

If the individual has previously participated in the health incentive system, previous health care provider claim processing information is retrieved and stored in the data warehouse. Step 108. Similarly, previous pharmacy provider claim processing information is retrieved and stored in the data warehouse. Step 110. The information obtained from the health care provider claim processing and the pharmacy provider claim processing is analyzed. Other information, such as physician referral information, patient self referral, and health quotient assessment information, could also be used. Step 112. The analysis determines whether the individual has a managed disease. Step 114. A managed disease is a chronic disease requiring continuing health care, such as asthma, hypertension or depression.

From the analysis of the information from the sources, commitments for the individual are determined. Step 116. The individual is provided with a notice of the commitments. Step 118. The notice could be displayed on personal computer 18, or the notice could be a hardcopy. The commitments are then stored. Step 120.

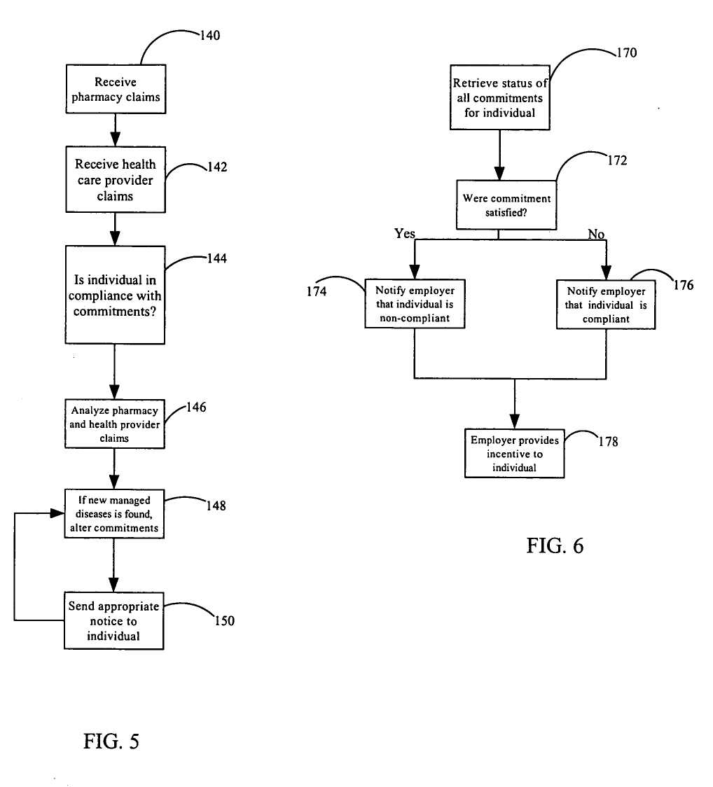

FIG. 5 shows the operation of the health care incentive system after the individual has completed the health assessment. Pharmacy claims and health care provider claims are regularly received and stored in data warehouse 10. Steps 140, 142.

The information from pharmacy claims and health care provider claims is indicative of the treatments received by the individual. On a regular schedule, the individual is evaluated as to whether she is in compliance with her commitments. Step 144. At the same time, the information from the claims is analyzed to determine if the individual has become afflicted with another managed disease during the plan year. Step 146. If a new managed disease has been found, the commitments are modified so as to incorporate the new managed disease. Step 148. A notice is then provided to the individual. Step 150.

In this way, the commitments are continually monitored by the health care incentive system to insure that the individual is performing the necessary steps to fulfill the commitments while appropriately managing her health.

FIG. 6 shows the operation of the health care incentive system at the end of the plan year. The statuses of the commitments are reviewed. Step 170. The system then determines whether all the commitments of the individual were met by this individual. Step 172. If all commitments have been met, then the successful completion of the commitments is noted to the employer. Step 174. If not, then that too is noted to the employer. Step 176. Based upon whether the individual successfully fulfilled her commitments, the employer then provides an incentive to the individual. Step 178.

The above description is of the preferred embodiment. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

The embodiments of the invention in which an exclusive property or privilege is claimed are defined as follows:

1. A health care incentive system for providing an incentive to an individual participating in a health care plan comprising:
a data warehouse for storing a health claim information and an individual commitment; and
a software means for comparing the health claim information with the individual commitment to determine whether the individual commitment was fulfilled.

2. The health care incentive system of claim 1 further comprising a health claim information system for providing the health claim information to the data warehouse.

3. The health care incentive system of claim 2 where the data warehouse stores a health quotient information.

4. The health care incentive system of claim 3 further comprising a health quotient information system for providing the health quotient information to the data warehouse.

5. The health care incentive system of claim 4 where the data warehouse further stores a group commitment.

6. The health care incentive system of claim 5 further comprising the individual commitment generation means for deriving the individual commitment from the group commitment information and the health quotient information.

7. The health care incentive system of claim 6 where the individual commitment generation means further includes a health knowledge system for determining if the individual has a managed disease.

8. The health care incentive system of claim 7 further comprising verification means for determining whether the individual fulfilled the individual commitment.

9. The health care incentive system of claim 8 where the verification means further comprises a claims accumulator for accumulating the claims information.

10. The health care incentive system of claim 9 where the verification means further comprises determining means for determining from the claims information whether the individual fulfilled the individual commitment.

11. A method for operating a health care incentive system to provide an incentive to an individual in a health care plan comprising:
determining a commitment for the individual;
tracking a performance of the individual relative to the commitment by analyzing health claim information;
and providing the incentive to the individual if the individual attains the commitment.

12. The method for operating a health care incentive system of claim 11 where the step of determining a commitment for the individual comprises:
by the individual, completing a on-line health assessment.

13. The method for operating a health care incentive system of claim 12 where the step of determining a commitment for the individual comprises:
obtaining a group commitment.

14. The method for operating a health care incentive system of claim 13 where the step of tracking the performance of the individual relative to the commitment by analyzing health claim information comprises:
accumulating health claim information;
analyzing the health claim information to determine if the individual has a managed diseases; and
further analyzing the health claim information to determine if the individual is obtaining treatment for the managed disease.

15. An information model comprising:
a commitment object maintaining a commitment of an individual; and
a member commitment status object for maintaining a status of the commitment with respect to the individual.

16. The information model of claim 15 further comprising:
a commitment version object maintaining a version of the commitment object.

17. The information model of claim 16 further comprising an incentive object for maintaining incentives for the individual.

18. The information model of claim 17 further comprising an employee class object.

19. The information model of claim 18 further comprising a commitment version object indicating a version of the commitment object associated with the individual.

20. The information model of claim 19 further comprising a goal object.

21. A method of operating a health care incentive system comprising:
setting a commitment for an individual in a health plan;
storing the commitment in a data warehouse;
obtaining claim information for the individual;
analyzing the claim information to determine if the individual obtained the commitment; and
providing an incentive to the individual is the individual obtained the commitment.

22. The method of claim 21 where the step of analyzing the claim information to determine if the individual obtained the commitment is performed by a computer software program.

23. The method of claim 22 where the claim information includes health care provider claim information.

24. The method of claim 23 where the claim information includes pharmacy claim information.

25. The method of claim 24 where the step of setting a commitment for an individual in a health plan includes the individual completing a health assessment survey.

26. The method of claim 25 where the step of setting a commitment for an individual includes having an employer of the individual determine an employer commitment.

27. The method of claim 26 where the employer commitment is stored in the data warehouse.

28. The method of claim 27 further comprising the step of determining if the individual has a managed disease.

29. The method of claim 28 where the step of analyzing the claim information to determine if the individual obtained the commitment comprises analyzing claim information.

30. The method of claim 29 where the step of analyzing claim information comprises analyzing health care provider claim information and pharmacy claim information.
